(19) United States
(12) Patent Application Publication
(10) Pub. No.: US 2025/0266757 A1
(43) Pub. Date: Aug. 21, 2025

(54) INDUCTOR ASSEMBLY, VRM MODULE AND PIN LAYOUT OF SEMICONDUCTOR SWITCH DEVICE

(71) Applicant: SHANGHAI METAPWR ELECTRONICS CO., LTD, Shanghai (CN)

(72) Inventors: Xiaoni Xin, Shanghai (CN); Mingzhun ZHANG, Shanghai (CN); Jianhong ZENG, Shanghai (CN)

(73) Assignee: SHANGHAI METAPWR ELECTRONICS CO., LTD, Shanghai (CN)

(21) Appl. No.: 19/057,980

(22) Filed: Feb. 20, 2025

(30) Foreign Application Priority Data
Feb. 20, 2024 (CN) 202410189719.8
Mar. 19, 2024 (CN) 202410311282.0
Jul. 17, 2024 (CN) 202410960993.0

(51) Int. Cl. H02M 3/00; H01F 27/26; H01F 27/29; H02M 1/00; H02M 3/158

(52) U.S. Cl. CPC H02M 3/003; H01F 27/266; H01F 27/292; H02M 1/0083; H02M 3/1584

(57) ABSTRACT

An inductor assembly includes an integrated inductor and signal assembly; the signal assembly includes a signal connector and a shielding layer; the shielding layer is arranged between the signal assembly and the integrated inductor, so that protecting the signal circuit from interference from the power circuit. A VRM module is provided. The VRM module includes an inductor assembly, a top assembly and a bottom assembly; the inductor assembly includes a magnetic core, a winding, VIN electrical connector and GND electrical connector; the top assembly includes a semiconductor switching device and an input capacitor; and an input power loop including VIN electrical connector, the GND electrical connector and the input capacitor is arranged around at least one part of the magnetic core.

### CROSS-REFERENCE TO RELATED APPLICATION

This application claims the priority benefit of Chinese patent application CN202410189719.8 filed on Feb. 20, 2024, and Chinese patent application CN202410311282.0 filed on Mar. 19, 2024, and Chinese patent application CN202410960993.0 filed on Jul. 17, 2024. The entirety of each of the above-mentioned patent applications is hereby incorporated by reference herein and made a part of this specification.

### BACKGROUND

### Technical Field

In recent years, with the development of technologies such as data centers, artificial intelligence, supercomputers and the like, more and more powerful ASICs are applied, such as CPUs, GPUs, machine learning accelerators, network switches, servers and the like, which consume a large amount of current, for example, the required current can reach thousands of amperes; and the current has the characteristic of rapid jump. A voltage regulation module (VRM, Voltage Regulator Modules, i.e., a voltage regulation module according to the present application), which comprises buck circuits (Buck), is traditionally used to supply such loads.

### Description of Related Art

As the load current continues to increase, the heat dissipation problem of the VRM module is increasingly prominent. In the prior art, in order to share the radiator with the load ASIC, the VRM module reduces the upward thermal resistance from the top surface of the VRM module, the switching device of the main heat source is arranged on the top surface of the VRM module, the output inductor is arranged below the switching device, and the bottom surface of the output inductor is connected to the system mainboard to supply power to the load. According to the scheme, the output inductor is arranged between the switch device and the VRM module pin, and power transmission and signal transmission between the top surface and the bottom surface pin of the VRM module are achieved through the power electrical connector and the signal electrical connector. Magnetic coupling exists between an input power loop formed by the power electrical connector and a signal loop formed by the signal electrical connector, so that the signal loop has the risk of being interfered by the magnetic field under the extreme condition.

### SUMMARY

In view of the above, one of the objectives of the present application is to provide an inductor assembly comprising an integrated inductor and a signal assembly; the integrated inductor comprises a magnetic core and a winding, the integrated inductor is provided with a side surface, a top surface and a bottom surface opposite to each other, the side surface comprises a first side surface, a second side surface, a third side surface and a fourth side surface; the second side surface and the fourth side surface are adjacent to the third side surface respectively.

A top surface connecting part is arranged on the top surface of the integrated inductor, and a bottom surface connecting part is arranged on the bottom surface of the integrated inductor.

The signal assembly comprises a signal electrical connector and a shielding layer, the shielding layer is disposed between the signal electrical connector and the magnetic core; the signal assembly is arranged close to the third side surface of the integrated inductor; the signal connector and the winding are connected with the top surface connecting part and the bottom surface connecting part.

Preferably, wherein the shielding layer is an inner metal layer; the signal assembly further comprises an outer metal layer; and the signal electrical connector is arranged between the outer metal layer and the inner metal layer; the inner metal layer is arranged adjacent to the third side surface of the integrated inductor.

Preferably, wherein the outer metal layer and the inner metal layer are used for an analog ground.

Preferably, wherein the outer metal layer and the inner metal layer are large-area copper laying layers.

Preferably, wherein copper laying or wiring of the outer metal layer and the inner metal layer is around the periphery of the signal assembly, and the wiring of the signal electrical connectors is distributed around the periphery of the signal assembly.

Preferably, wherein the outer metal layer, the inner metal layer and the signal connector are arranged in a vertical plate.

Preferably, wherein the winding comprises a first winding and a second winding; an air gap is formed between the first winding and the second winding; and the coupling coefficient between the first winding and the second winding is greater than or equal to 0.2.

Preferably, wherein the winding comprises a first winding and a second winding, and the first winding and the second winding are both “Z”-shaped copper sheets; the first winding and the second winding both comprise a main body part, and the main body part of the first winding and the main body part of the second winding are arranged in parallel.

Preferably, wherein the top surface connecting part of the first winding and the second winding are both disposed adjacent to the first side surface, and the bottom surface connecting part of the first winding and the second winding are both disposed adjacent to the third side surface.

Preferably, wherein the top surface connecting part of the first winding and the bottom surface connecting part of the second winding are arranged close to the second side surface; and the bottom surface connecting part of the first winding and the top surface connecting part of the second winding are arranged close to the fourth side surface.

Preferably, wherein two ends of the main body part of each winding are respectively exposed out of two opposite side surfaces of the magnetic core.

Preferably, wherein the winding comprises a first winding and a second winding, and the first winding and the second winding penetrate through the bottom surface from the top surface of the magnetic core.

A VRM module comprises an inductor assembly and a top assembly; the top assembly is disposed on the top surface of the inductor assembly, and the top assembly is electrical connected with the top surface connecting part.

Preferably, wherein the VRM module further comprises a bottom assembly; the bottom assembly is disposed on the bottom surface of the inductor assembly, and the bottom assembly is electrical connected with the bottom surface connecting part; the bottom assembly is used for being connected with a load; the top assembly and/or the bottom assembly is electrical connected with a power ground.

Preferably, wherein the VRM module further comprises a first power electrical connector and a second power electrical connector, and the first power electrical connector and the second power electrical connector are respectively disposed adjacent to different side surfaces of the integrated inductor; the first power electrical connector and the second power electrical connector form a top surface power connecting part on the top surface of the integrated inductor respectively, and the top surface power connecting part is connected with the corresponding top assembly; the first power electrical connector and the second power electrical connector form a bottom surface power connecting part on the bottom surface of the integrated inductor respectively, the bottom surface connector bonding pad is used for being connected with the input end of the VRM module, and the input end is a power input end; the shielding layer is an inner metal layer; the signal assembly further comprises an outer metal layer; and the signal electrical connector is arranged between the outer metal layer and the inner metal layer; the inner metal layer is arranged adjacent to the third side surface of the integrated inductor; the outer metal layer and the inner metal layer are used for an analog ground; the analog ground is electrical connected with the power ground through the top assembly and/or the bottom assembly.

Preferably, wherein the top assembly comprises a semiconductor switching device; the top surface connecting part of the winding is vertically corresponding to and electrically connected with the connecting end of the semiconductor switching device.

Preferably, wherein the top assembly further comprises an input capacitor, and an electrical loop comprising the first power electrical connector, the second power electrical connector and the input capacitor, the electrical loop surrounds at least a part of the magnetic core.

Preferably, wherein the first power electrical connector is a VIN electrical connector, and the second power electrical connector is a GND electrical connector; the first power electrical connector is arranged close to the third side surface or the first side surface of the integrated inductor; and the second power electrical connector is arranged adjacent to the second side surface and the fourth side surface.

Preferably, wherein the first power electrical connector is a VIN electrical connector, and the second power electrical connector is a GND electrical connector; the first power electrical connector is arranged adjacent to the first side surface of the integrated inductor; and the second power electrical connector is arranged adjacent to the third side surface, the second side surface and/or the fourth side surface.

Preferably, wherein the width of the second power electrical connector disposed adjacent to the third side surface is equal to or less than the width of the third side surface of the integrated inductor.

Preferably, wherein the first power electrical connector and the second power electrical connector are metal sheets, and the first power electrical connector and the second power electrical connector are assembled with the magnetic core or sintered together.

Preferably, wherein the VRM module further comprising a groove; the groove is disposed on the third side surface or the first side surface of the integrated inductor; the first power electrical connector is disposed in the groove of the third side surface or in the groove of the first side surface of the integrated inductor.

Preferably, wherein the magnetic core comprises a magnetic core main body and an auxiliary magnetic core, the first power electrical connector is arranged in a groove on the third side surface of the magnetic core main body, and the auxiliary magnetic core is arranged between the first power electrical connector and the signal assembly.

Preferably, wherein the material of the auxiliary magnetic core can be a material of the magnetic core main body, a magnetic adhesive having different equivalent magnetic permeability to the magnetic core main body, or other types of alloy magnetic materials.

Preferably, wherein the first power electrical connector and the second power electrical connector are formed by bending a rectangular copper sheet; a placement groove is formed in the position on the surface of the magnetic core, the position is corresponding to the first power electrical connector and the second power electrical connector; and the tail end of the second power electrical connector is arc-shaped.

Preferably, there are two semiconductor switch devices, the semiconductor switch devices comprise signal pins, and the signal pins are arranged adjacent to the third side surface; the VRM module further comprises an input capacitor, and the input capacitor is arranged between the semiconductor switch devices and adjacent to the third side surface.

Preferably, wherein the semiconductor switching device comprises a first semiconductor switching device and a second semiconductor switching device, and each semiconductor switching device comprises an SW end; the SW end of the first semiconductor switching device is arranged adjacent to the first side surface, and the SW end of the second semiconductor switching device is arranged adjacent to the third side surface; and the VRM module further comprises an input capacitor, and the input capacitor is arranged around and between the semiconductor switching device.

A VRM module comprises a top assembly, an inductor assembly and a bottom assembly; the inductor assembly comprises an integrated assembly and a signal assembly; the integrated assembly comprises a power electrical connector, a magnetic core and a winding.

The integrated inductor is provided with a side surface, a top surface and a bottom surface opposite to each other, the side surface comprises a first side surface, a second side surface, a third side surface and a fourth side surface; the second side surface and the fourth side surface are adjacent to the third side surface respectively.

The signal assembly comprises a signal electrical connector.

A top surface connecting part is arranged on the top surface of the integrated inductor, and a bottom surface connecting part is arranged on the bottom surface of the integrated inductor; the power electrical connector, the signal electrical connector and the winding are electrical connected with the top surface connecting part and the bottom surface connecting part.

The power electrical connector comprises a power ground electrical connector; the signal electrical connector is arranged adjacent to the power ground electrical connector.

The inductor assembly is arranged between the top assembly and the bottom assembly; the top assembly and the bottom assembly are electrical connected with the inductor assembly through the top surface connecting part and the bottom surface connecting part.

Preferably, wherein the signal assembly further comprises an inner metal layer and an outer metal layer; and the signal electrical connector is arranged between the outer metal layer and the inner metal layer; the inner metal layer is arranged adjacent to the third side surface of the integrated inductor; the outer metal layer and the inner metal layer are used for an analog ground; the analog ground is electrical connected with the power ground electrical connector through the top assembly and/or the bottom assembly.

Preferably, wherein the power ground electrical connector is the second power electrical connector; the power electrical connector further comprises a first power electrical connector; the first power electrical connector is arranged adjacent to the first surface of the integrated inductor.

A pin layout of a semiconductor switch device, wherein the pin comprises a Vin+ pin, an SW pin, a power ground pin and a signal pin area; the semiconductor switch device comprises a first side surface and a third side surface which are opposite to each other, and a second side surface and a fourth side surface which are opposite to each other; the Vin+ pin is adjacent and is arranged along the first side surface; the signal pin area is adjacent and is arranged along the third side surface; the power ground pin is arranged between the Vin+ pin and the signal pin area; and the SW pin is arranged between the Vin+ pin and the power ground pin.

Preferably, wherein the signal pin area comprises a control signal pin, a state pin and an analog ground pin of the semiconductor switch device.

Preferably, wherein the semiconductor switch device is a single wafer and comprises an upper switch QH area, a lower switch QL area and a LOGICAL area; the upper switch QH area is arranged adjacent to the first side surface, and the LOGICAL area is arranged adjacent to the third side surface; and the lower switch QL area is arranged between the upper switch QH area and the LOGICAL area.

Preferably, wherein the semiconductor material in the upper switch QH area exceeds 50%.

Compared with the prior art, the application has the following beneficial effects.

(1) According to the VRM module provided by the application, the magnetic field coupling between the signal loop and the input power loop is reduced by optimizing the arrangement between the input power loop and the signal loop, so that the VRM module can work reliably under the extreme condition.

### BRIEF DESCRIPTION OF THE DRAWINGS

FIG. 1 is a schematic circuit diagram of a VRM module;

FIG. 2A to FIG. 2E are schematic diagrams of a first embodiment of the present application;

FIG. 3A to FIG. 3B are schematic diagrams of a second embodiment of the present application;

FIG. 4A to FIG. 4B are schematic diagrams of a third embodiment of the present application;

FIG. 5A to FIG. 5B are schematic diagrams of a fourth embodiment of the present application;

FIG. 6A to FIG. 6C are schematic diagrams of a fifth embodiment of the present application;

FIG. 7A to FIG. 7C are schematic diagrams of a sixth embodiment of the present application;

FIG. 8A to FIG. 8B are schematic diagrams of a seventh embodiment of the present application;

FIG. 9A to FIG. 9F are schematic diagrams of an eighth embodiment of the present application;

FIG. 10A to FIG. 10C are schematic diagrams of a ninth embodiment of the present application; and

FIG. 11A to FIG. 11D are schematic diagrams of a tenth embodiment of the present application.

### DESCRIPTION OF THE EMBODIMENTS

One of the objectives of the present application is to reduce magnetic field coupling between a signal loop and an input power loop by optimizing the setting between an input power loop and a signal loop, thereby enabling reliable operation of the VRM module in an extreme case.

According to the technical scheme in the embodiment of the application, the technical scheme in the embodiment of the application is clearly and completely described below in combination with the drawings in the embodiment of the application, obviously, the described embodiments are only a part but not all of the embodiments of the present application. All other embodiments obtained by a person of ordinary skill in the art based on the embodiments of the present application without creative efforts shall fall within the protection scope of the present application.

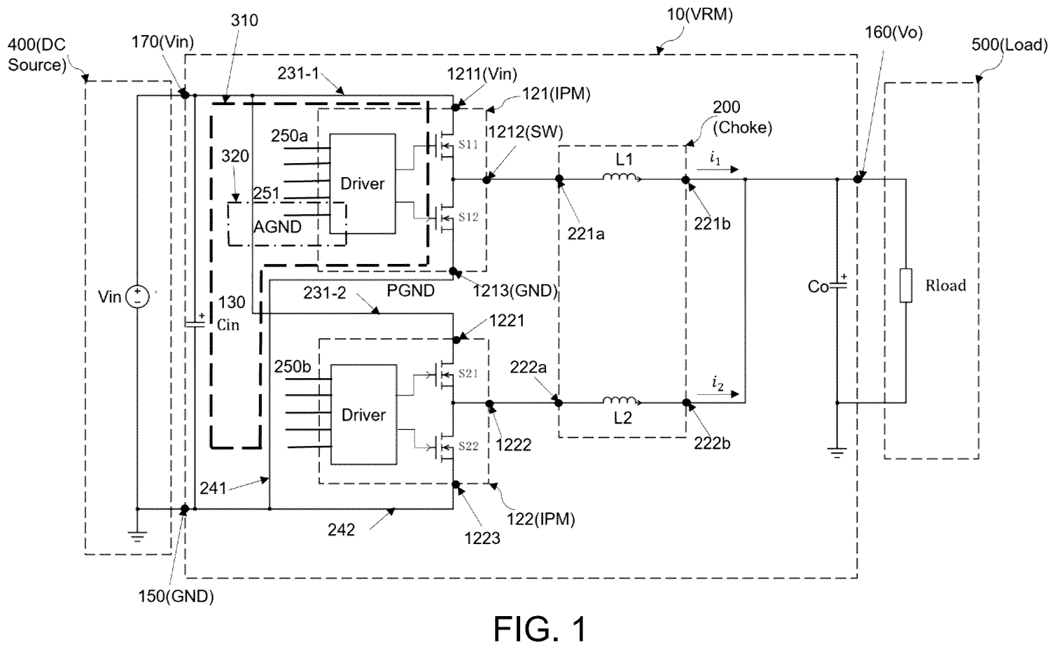

FIG. 1 is a schematic circuit diagram of a VRM module. As shown in FIG. 1, the present application provides a VRM module 10, comprising an IPM unit 121, an IPM unit 122, a VIN electrical connector 231-1, a VIN electrical connector 231-2, a GND electrical connector 241, a GND electrical connector 242, an input capacitor 130, a signal electrical connector 250a and a signal electrical connector 250b. The IPM units 121/122 each comprise two semiconductor switch devices which are respectively an upper switch and a lower switch, the switch can be at least one of a MOSFET (Metal-Oxide-Semiconductor Field Effect Transistor), an SiC and a GaN; in the present application, the switch is described by taking an MOSFET as an example. The two MOSFETs are connected in series to form a bridge arm. One end of the bridge arm is connected to the input voltage end VIN 170 through the VIN electrical connector 231-1 or 231-2; the other end of the bridge arm is connected to the ground end GND 150 through the GND electrical connector 241 or 242. The midpoints of the bridge arm corresponding to the IPM unit 121/122 are the SW end 1212/1222; the SW end 1212/1222 is connected with the input end of the corresponding output inductor respectively; the output ends of the output inductors are connected with the load 500 in parallel or individually, and energy is provided for the load. The input capacitor 130 is used for bypassing the high-frequency switch ripple current generated by the IPM unit 121/122, so as to ensure that the input voltage is stable; and the signal electrical connector 250a/250b is used for transmitting a sampling signal of the IPM unit 121/122, and transmitting a driving signal or a control signal required by the IPM unit 121/122.

### Embodiment 1

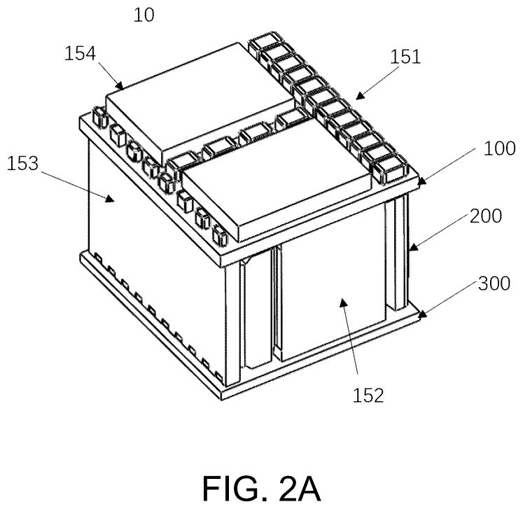

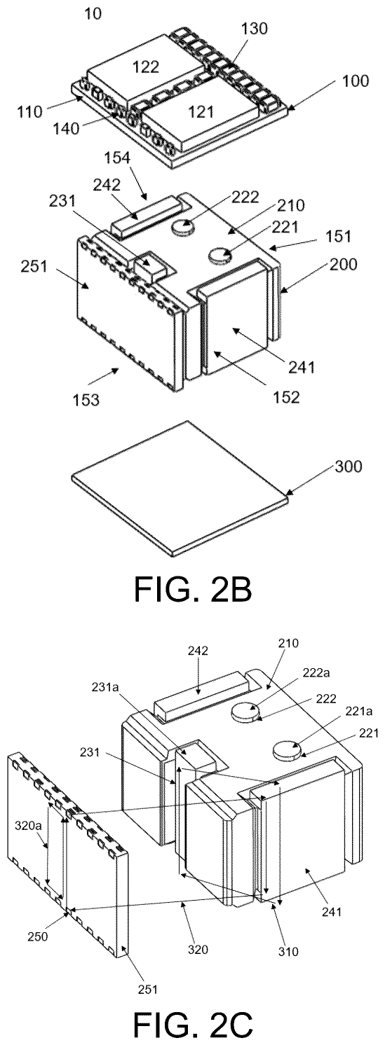

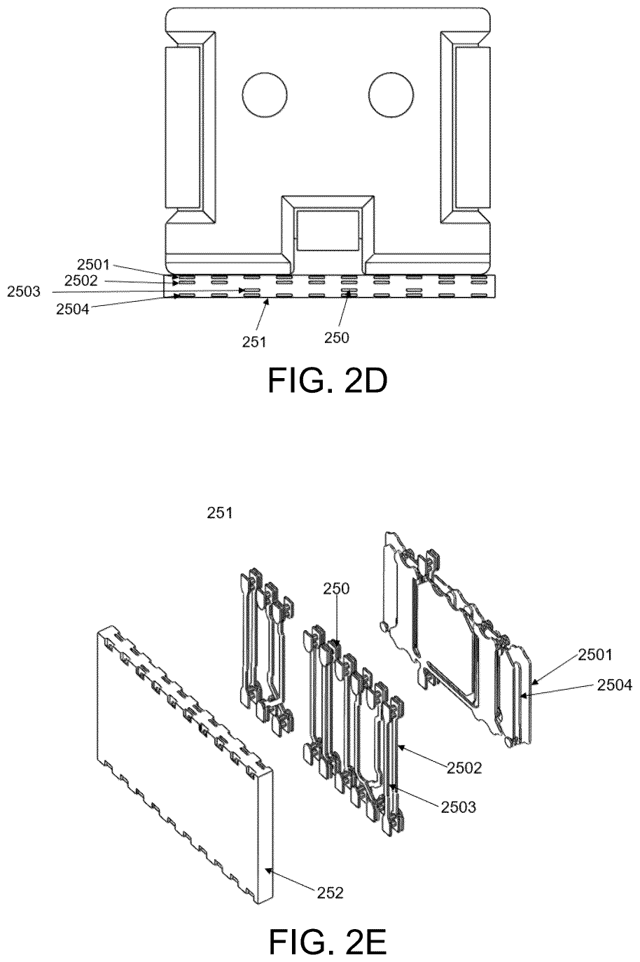

FIG. 2A is a schematic structural diagram of a VRM module 10 according to the embodiment, and the circuit diagram and element naming of the VRM module 10 are basically in one-to-one correspondence with FIG. 1; FIG. 2B is an exploded view of FIG. 2A; FIG. 2C is a schematic structural diagram of an integrated inductor; FIG. 2D is a top view of an integrated inductor; and FIG. 2E is an exploded view of the signal assembly. As shown in FIGS. 2A-2E, the VRM module 10 comprises a top assembly 100, an inductor assembly 200 and a bottom assembly 300, wherein the top assembly 100 comprises a first substrate 110, an IPM unit 121, an IPM unit 122, a plurality of input capacitors 130 and other passive elements 140. The first substrate 110 comprises a first side surface 151, a second side surface 152, a third side surface 153, and a fourth side surface 154; and the four side surfaces sequentially satisfy a clockwise rotation relationship.

The other passive elements 140 are mainly used for filtering at the control pins of the IPM units 121/122, the control pins of the IPM units 121/122 are arranged adjacent to the third side surface 153 of the first substrate 110; in order to obtain a better filtering effect, the other passive elements 140 are arranged between the third side surface 153 of the first substrate and the IPM units 121/122. In the embodiment, the input capacitor 130 is divided into two parts, one part is arranged adjacent to the first side surface 151 of the first substrate 110, and the other part is arranged between the two IPM units 121/122.

As shown in FIG. 2B, the inductor assembly 200 includes a first power electrical connector 231, a second power electrical connector 241 and 242, an integrated inductor, and a signal assembly 251; optionally, the first power electrical connector is a VIN electrical connector, and the second power electrical connector is a GND electrical connector; the Vin electrical connector 231 corresponds to the combination of the Vin electrical connectors 231-1 and 231-2 in FIG. 1; the signal assembly 251 integrates the signal electrical connectors 250a and 250b in FIG. 1. The integrated inductor comprises a magnetic core 210, and a first winding 221 and a second winding 222; the first winding 221 and the second winding are surrounded by the magnetic core 210. In the embodiment, the first winding 221 and the second winding 222 are best in an “I”-shaped copper column. The magnetic core 210 has side surfaces, and the side surfaces of the magnetic core 210 are the same as the side surface of the integrated inductor, the side surface of the VRM module and the side surface of the first substrate 110. An electrical loop comprising the VIN electrical connector 231, the GND electrical connector 241/242 and the input capacitor 130 surrounds at least a portion of the magnetic core 210. Optionally, the VIN electrical connector 231 and the GND electrical connector 241/242 are respectively disposed on different side surfaces of the integrated inductor.

As shown in FIG. 2C, the signal assembly 251 includes a signal electrical connector 250 disposed adjacent to a third side surface 153 of the magnetic core. The top assembly 100 is electrical connected with the bottom assembly 300 through a signal electrical connector 250 (250 corresponding to 250a and 250b in FIG. 1) in the signal assembly 251. Due to the fact that parasitic inductance exists in the input power loop 310 which comprises the VIN electrical connector 231, the input capacitor 130 and the GND electrical connector 241/242, the parasitic inductance and the input capacitor 130 generate resonance, which is referred to as an input power loop resonance for short. If the resonant frequency is close to the equivalent switching frequency of the two-phase VRM module 10, the normal operation of the VRM module is interfered, and the conversion efficiency of the VRM module is reduced. Increasing the parasitic inductance of the input power loop 310 and/or increasing the equivalent capacitance of the input capacitor 130 can reduce the resonant frequency of the input power loop resonance, so that the resonant frequency is far lower than the equivalent switching frequency of the VRM, and the efficiency of the VRM is prevented from reducing. According to the embodiment of the application, the VIN electrical connector 231 and the GND electrical connector 241/242 are arranged on different side surfaces of the integrated inductor, and the parasitic inductance of the input power loop is increased by utilizing the corner part of the magnetic core 210.

The VIN electrical connector 231 functions as a corresponding VIN electrical connector 231-1/231-2 in FIG. 1; and the GND electrical connector 241/242 functions as the GND electrical connector 241/242 in FIG. 1; the Vin electrical connector 231 is provided with a first bonding pad 231a on the top surface and a second bonding pad 231b on the bottom surface; the GND electrical connector 241/242 is provided with a first bonding pad 241a/242a on the top surface and a second bonding pad 241b/242b on the bottom surface. The first winding 221 is provided with a first bonding pad 221a on the top surface of the integrated inductor and is used for being connected with an SW end of the IPM unit 121 of the top assembly 100; and the first winding 221 is provided with a second bonding pad 221b at the bottom surface of the integrated inductor and used for being connected with an output positive end (Vo end) 160 on the bottom assembly 300 to supply power to the load 500; the second winding 222 is provided with a first bonding pad 222a on the top surface of the integrated inductor and is used for being connected with the SW end of the IPM unit 122 of the top assembly 100; the second winding 222 is provided with a second bonding pad 222b on the bottom surface of the integrated inductor and is used for being connected with the output positive end (Vo end) 160 on the bottom assembly 300 to supply power to the load 500.

In the embodiment, the VIN electrical connector 231 and the GND electrical connector 241/242 are assembled with the magnetic core 210 together through the metal copper sheet; in other embodiments, the metal copper sheet and the magnetic core 210 can also be sintered together. Specifically, as shown in FIG. 2C, the VIN electrical connector 231 is disposed adjacent to the third side surface 153 of the magnetic core 210; the GND electrical connector 241 is disposed adjacent to the second side surface 152 of the magnetic core 210; the GND electrical connector 242 is disposed adjacent to the fourth side surface 154 of the magnetic core 210. The signal assembly 251 is disposed adjacent to the third side surface 153 of the magnetic core 210. The first power electrical connector is arranged adjacent to the third side surface of the integrated inductor. Specifically, the first power electrical connector 231 is arranged in a groove in the third side surface of the magnetic core, and the groove is a vertically extending groove.

As shown in FIG. 2E, the signal assembly 251 in the embodiment comprises a multilayer wiring layer, preferably, the signal assembly 251 is a multilayer wiring board, and the multilayer wiring layer comprises at least two layers. As an example, the signal assembly 251 comprises four wiring layers, and specifically comprises an inner metal layer 2501, a first interlayer 2502, a second interlayer 2503 and an outer metal layer 2504 arranged sequentially, and the four layers are all arranged in the substrate 252; the inner metal layer 2501 is adjacent to the magnetic core 210. The wiring layers in the first interlayer 2502 and the second interlayer 2503 are used for forming the signal electrical connector 250; the inner metal layer 2503 and the outer metal layer 2504 are both copper laying layers with a large area, and is used for forming an analog ground wiring (defined as AGND), and is short-circuited with the GND electrical connector 241/242 on the top assembly 100 and/or the bottom assembly 300. The advantage of this arrangement is that the inner metal layer 2501 can shield the voltage jump on the first winding 221 and the second winding 222, so that the signal electrical connectors 250a and 250b are not interfered by the electric field.

Another preferred solution, 2501 and 2504 can be respectively configured to analog ground and power ground, so that a loop area between a signal ground and a power ground is small, which is beneficial to reduce noise interference between a power ground and a signal ground, and improve the reliability of the module.

### Embodiment 2

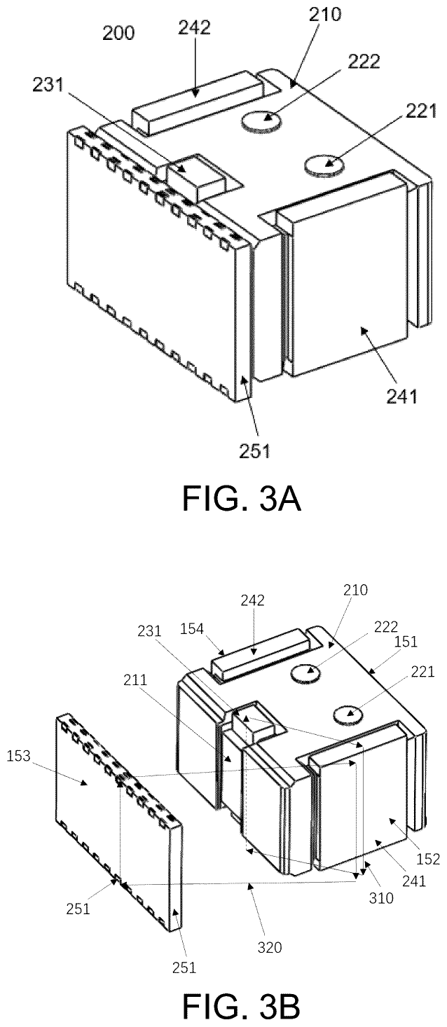

FIG. 3A is a schematic structural diagram of an inductor assembly 200 of the present embodiment, and FIG. 3B is an exploded view of FIG. 3A. As shown in FIGS. 3A-3B, the embodiment has a similar technical effect as Embodiment I. The difference between the embodiment and Embodiment I lies in that the magnetic core comprises a magnetic core main body 210 and an auxiliary magnetic core 211; the VIN electrical connector 231 is arranged on the magnetic core and is adjacent to the third side surface 153; specifically: the VIN electrical connector 231 is arranged in a groove on the magnetic core main body 210, the groove is located on the third side surface 153 of the magnetic core main body 210; the auxiliary magnetic core 211 is arranged on the outer side of the VIN electrical connector 231; the outer side is one side and away from the center of the magnetic core body 210. Optionally, the auxiliary magnetic core 211 is also arranged in the groove, so that the VIN electrical connector 231 is surrounded by the magnetic core; the auxiliary magnetic core 211 can be a magnetic block made of the same magnetic material as the magnetic core main body 210, magnetic glue with different equivalent magnetic permeability, or other types of alloy magnetic materials, such as an iron-manganese alloy; and after the auxiliary magnetic core 211 is arranged, the parasitic inductance of the input power loop 310 comprising the VIN electrical connector, the GND electrical connector and the input capacitor 130 can be improved, and it is ensured that the resonant frequency of the input power loop resonance does not affect the normal work of the VRM module.

### Embodiment 3

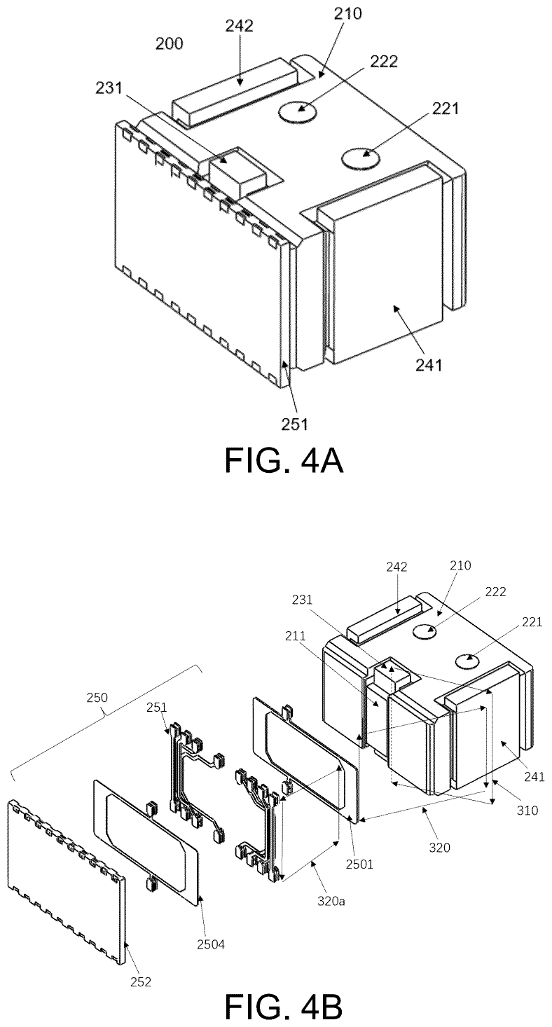

FIG. 4A is a schematic structural diagram of an inductor assembly 200 of the present embodiment, and FIG. 4B is an exploded view of FIG. 4A. As shown in FIG. 4A to FIG. 4B, the embodiment and the second embodiment have similar technical effects; the difference between this embodiment and the second embodiment lies in that: the wiring shape of the wiring layer in the signal assembly 251 is different; the wiring on the wiring layer of the signal assembly 251 is located on the periphery of the signal assembly 251 and is a “ ” shape; specifically, 1) copper laying or wiring of the inner metal layer 2501 and the outer metal layer 2502 is around the periphery of the signal assembly, and no copper laying or wiring is arranged in the middle of the two metal layers; 2) the wiring of the first interlayer 2502 and the second interlayer 2503 is also arranged around the periphery of the signal assembly 251, and no wiring is arranged in the middle of the two interlayers. The“ ”-shaped wiring further increases the parasitic inductance of the input power loop 310, so that the resonant frequency of the input power loop resonance is further away from the equivalent switching frequency of the VRM module, and it is ensured that the resonant frequency of the input power loop does not affect the normal operation of the VRM module.

### Embodiment 4

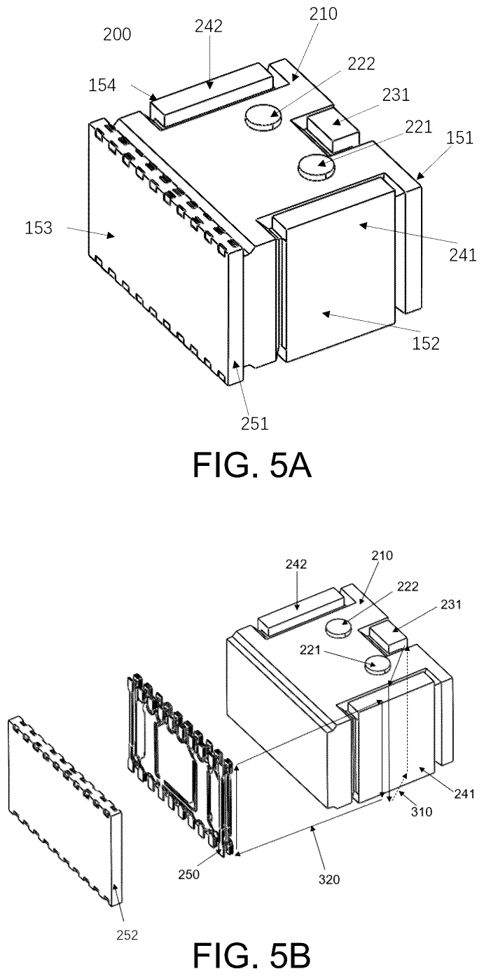

FIG. 5A is a schematic structural diagram of an inductor assembly 200 of the present embodiment, and FIG. 5B is an exploded view of FIG. 5A. As shown in FIG. 5A to FIG. 5B, the embodiment has a similar technical effect as the first embodiment. The difference between this embodiment and the first embodiment lies in that the VIN electrical connector 231 is arranged adjacent to the first side surface 151 of the magnetic core 210; the signal assembly 251 is still arranged adjacent to the third side surface 153 of the magnetic core 210, that is, the signal assembly 251 and the VIN electrical connector are arranged on the two opposite side surfaces of the magnetic core 210 respectively; so that the input power loop 310 has a larger loop parasitic inductance; and a signal loop 320 is arranged at a position away from the input power loop 310, wherein the signal loop 320 comprise the signal electrical connectors 250a and 250b, or comprises the signal electrical connector 250a and the GND electrical connector, or comprises the signal electrical connector 250b and the GND electrical connector; that is, the distance between the signal loop 320 and the input power loop 310 is increased. Therefore, the magnetic coupling between the input power loop 310 and the signal loop 320 is weakened; the effect of the signal loop 320 resisting magnetic field interference is better, and the operation reliability of the VRM module under extreme working conditions is improved.

### Embodiment 5

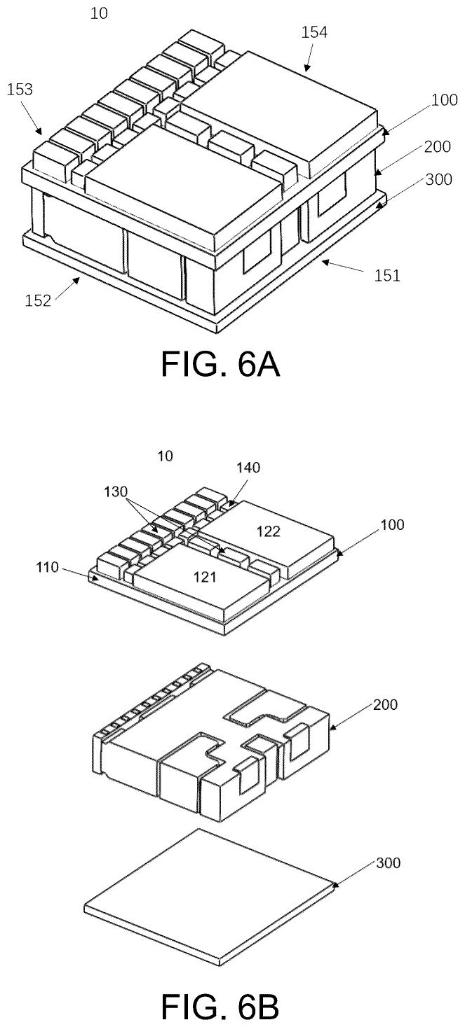

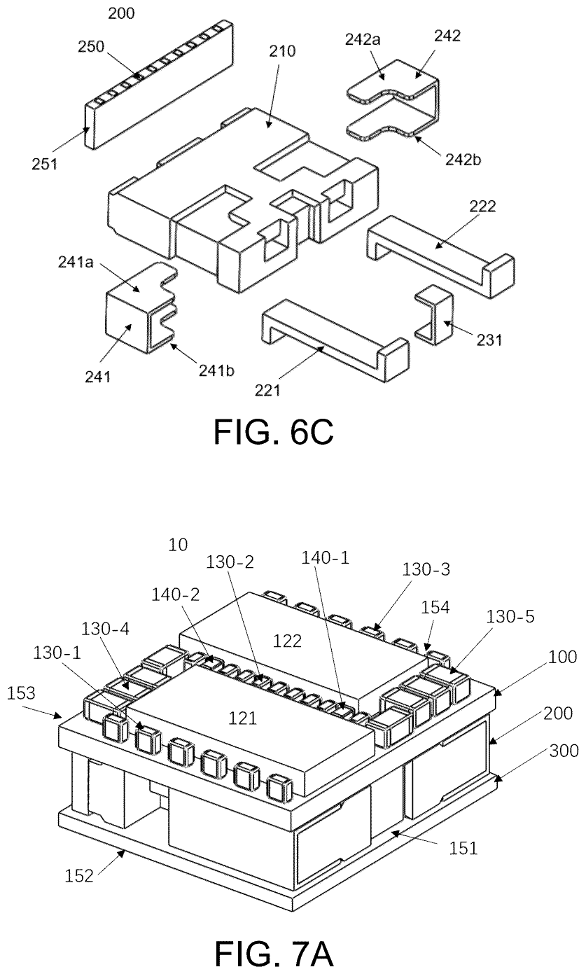

FIG. 6A is a schematic structural diagram of a VRM module 10 of the present embodiment, FIG. 6B is an exploded view of FIG. 6A, and FIG. 6C is an exploded view of the inductor assembly. As shown in FIGS. 6A-6C, the two-phase VRM module 10 in the embodiment comprises a top assembly 100, an inductor assembly 200 and a bottom assembly 300; wherein the top assembly 100 comprises a first substrate 110, an IPM unit 121/122, an input capacitor 130 and other passive elements 140; the IPM unit 121/122 is disposed adjacent to the first side surface 151 of the first substrate 110; the signal pins of the IPM units 121/122 are arranged in a direction opposite to the first side surface of the first substrate 110, that is, adjacent to the third side surface 153 of the first substrate 110; and the other passive elements 140 are arranged close to the third side surface of the first substrate 110 and are tightly attached to the positions of the IPM units 121/122; the input capacitor 130 is arranged between the IPM units 121/122 and adjacent to the third side surface 153 of the first substrate 110.

As shown in FIG. 6C, the inductor assembly 200 comprises a magnetic core 210, a first winding 221, a second winding 222, a VIN electrical connector 231, a GND electrical connector 241, a GND electrical connector 242 and a signal assembly 251; there is no coupling relationship between the first winding 221 and the second winding 222, or only weak positive coupling is present, for example, the coupling coefficient is less than 0.2. The first winding 221 and the second winding 222 are both “Z”-shaped copper sheets, penetrate through the third side surface 153 of the magnetic core from the first side surface 151 of the magnetic core 210; one end extends from the first side surface to the top surface of the magnetic core, and form pins on the top surface of the magnetic core; the other end extends from the third side surface to the bottom surface of the magnetic core, and pins are formed on the bottom surface of the magnetic core; the main body parts of the first winding 221 and the second winding 222 are parallel to the top surface of the magnetic core 210.

The Vin electrical connector 231 is disposed adjacent to the first side surface 151; the GND electrical connector 241 is arranged adjacent to the second side surface 152 of the magnetic core 210; the GND electrical connector 242 is arranged adjacent to the fourth side surface 154 of the magnetic core 210; the signal assembly 251 is arranged adjacent to the third side surface 153 of the magnetic core 210; that is, the VIN electrical connector 231 and the signal assembly 251 are arranged on two opposite side surfaces. Optionally, the VIN electrical connector and the GND electrical connector are both formed by bending a rectangular copper sheet. The tail end of the GND electrical connector is arc-shaped. The surface of the magnetic core is provided with a placement groove corresponding to the VIN electrical connector and the GND electrical connector; the placement groove is adapted to the shape of the VIN electrical connector and the GND electrical connector. The performance of the signal loop's anti-interference in the embodiment is the same as that of implementation 4, wherein the interference is from the input power loop, and details are not described herein again.

### Embodiment 6

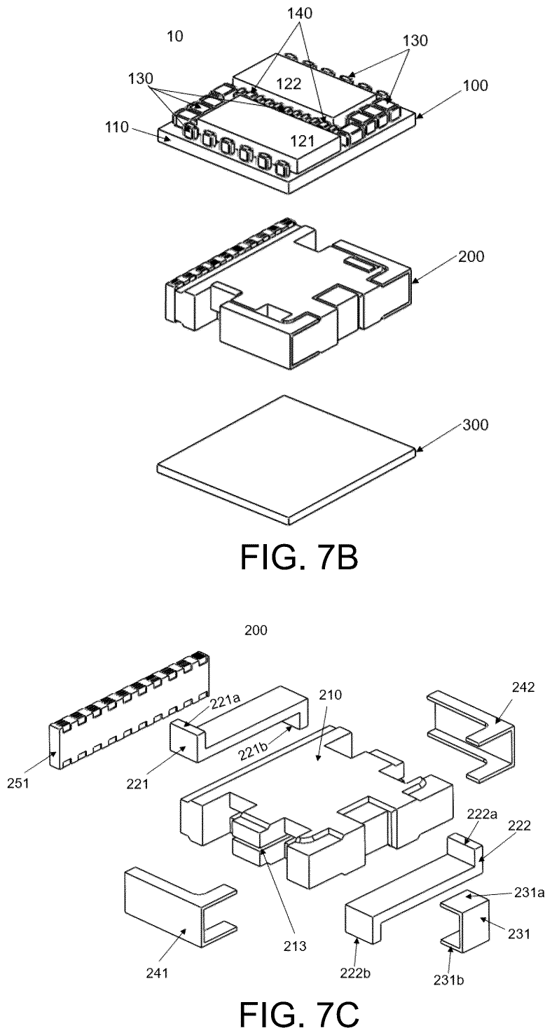

FIG. 7A is a schematic structural diagram of a VRM module 10 of the present embodiment, FIG. 7B is an exploded view of FIG. 7A, and FIG. 7C is an exploded view of the inductor assembly. As shown in FIGS. 7A-7C, the two-phase VRM module 10 of the embodiment comprises a top assembly 100, an inductor assembly 200 and a bottom assembly 300 which are sequentially arranged from top to bottom; the top assembly 100 comprises a first substrate 110, an IPM unit 121/122, an input capacitor 130 and other passive elements 140; and the IPM unit 121 is arranged on the first substrate 110 and is adjacent to the first side surface 151; and an SW end of the IPM unit 121 is adjacent to a third side surface 153 of the first substrate 110; the IPM unit 122 is arranged on the first substrate 110 and is adjacent to the third side surface 153; the SW end of the IPM unit 122 is adjacent to the first side surface 151 of the first substrate 110; the input capacitor 130 is arranged around the IPM units 121 and 122, and is arranged between the IPM units 121 and 122; for example, 130-1, 130-2, 130-3, 130-4 and 130-5, a better filtering effect is achieved. Other passive elements 140 are disposed between the two-phase IPM units 121 and 122, such as 140-1 and 140-2, and respectively disposed adjacent to the signal pins of the two-phase IPM unit.

As shown in FIG. 7C, the integrated inductor 200 comprises a magnetic core 210, a first winding 221, a second winding 222, a VIN electrical connector 231, a GND electrical connector 241, a GND electrical connector 242, and a signal assembly 251.

Both the first winding 221 and the second winding 222 penetrate through the fourth side surface 154 from the second side surface 152 of the magnetic core 210; wherein a first winding bonding pad (i.e., a first bonding pad 221a) of the first winding 221 extends from the second side surface 152 to the top surface, and a second winding bonding pad (i.e., a second bonding pad 221b) of the first winding 221 extends from the fourth side surface 154 to the bottom surface; a first winding bonding pad (i.e., a first bonding pad 222a) of the second winding 222 extends from the fourth side surface 154 to the top surface, and a second winding bonding pad (i.e., a second bonding pad 222b) of the second winding 222 extends from the second side surface 152 to the bottom surface. The main body parts of the first winding 221 and the second winding 222 are parallel to the top surface of the magnetic core 210, and the main body parts of the first winding 221 and the second winding 222 are also parallel to each other. The first winding is disposed adjacent to the third side surface 153 of the magnetic core 210 and is parallel to the third side surface 153. The second winding 222 is disposed adjacent to the first side surface 151 of the magnetic core 210 and is parallel to the first side surface 151.

In the magnetic core 210, an air gap 213 is provided between the first winding 221 and the second winding 222; the air gap may be filled with air or a magnetic material, and the magnetic permeability of the magnetic material is lower than that of the magnetic core 210. Optionally, the air gap 213 is parallel to the top surface of the magnetic core 210. In the embodiment, the coupling coefficient between the first winding 221 and the second winding 222 is greater than or equal to 0.2.

The VIN electrical connector 231 is disposed adjacent to the first side surface 151 of the magnetic core 210.

The GND electrical connector 241 is disposed adjacent to the second side surface 152 of the magnetic core, and the GND electrical connector 242 is disposed adjacent to the fourth side surface 154 of the magnetic core; the signal assembly 251 is disposed adjacent to the third side surface 153 of the magnetic core 210; the performance of the signal loop's anti-interference in the embodiment is the same as that of the embodiment shown in FIG. 6B, wherein the interference is from the input power loop, and details are not described herein again.

### Embodiment 7

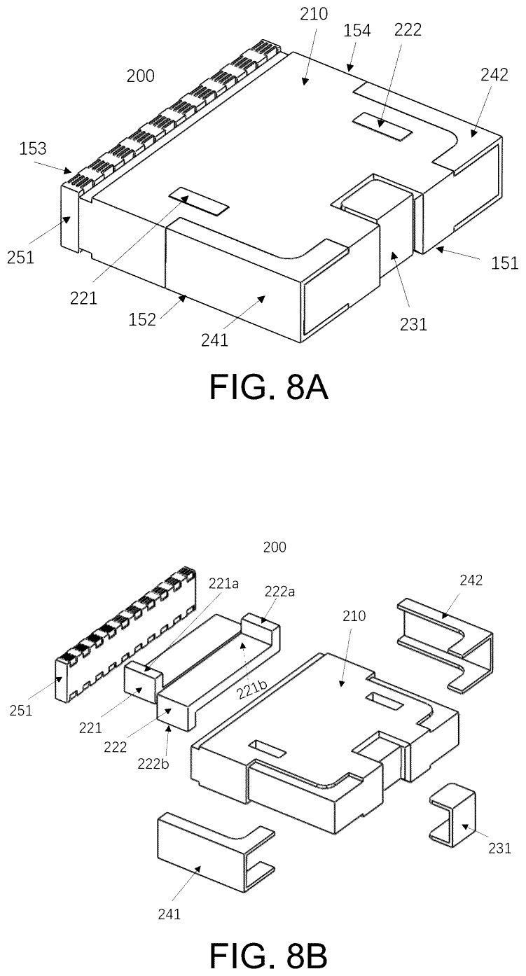

FIG. 8A is another embodiment of the inductor assembly 200 in the VRM module 10 of the present embodiment, and FIG. 8B is an exploded view of FIG. 8A. As shown in FIG. 8A and FIG. 8B, the inductor assembly 200 in the present embodiment comprises a magnetic core 210, a first winding 221, a second winding 222, a VIN electrical connector 231, a GND electrical connector 241 and 242, and a signal assembly 251.

Neither the first winding 221 nor the second winding 222 passes through the second side surface 152 and the fourth side surface 154 of the magnetic core 210; wherein the first winding 221 extends from one end adjacent to the second side surface 152 to the top surface to form a top surface bonding pad 221a (i.e., a first bonding pad 221a) of the first winding, and the first winding 221 extends from one end adjacent to the fourth side surface 154 to the bottom surface to form a bottom surface bonding pad 221b (i.e., a second bonding pad 221b) of the first winding; the second winding 222 extends from one end adjacent to the fourth side surface 154 to the top surface to form a top surface bonding pad 222a (i.e., a first bonding pad 222a) of the second winding, and the second winding 222 extends from one end adjacent to the second side surface 152 to the bottom surface to form a bottom surface bonding pad 222b (i.e., a second bonding pad 222b) of the second winding. The main body part of the first winding 221 and the main body part of the second winding 222 are parallel to each other, are arranged adjacent to each other and are parallel to the top surface of the magnetic core 210; and the distance between the first winding 221 and the second winding 222 meets the electrical isolation between the first winding 221 and the second winding 222.

The difference between this embodiment and the sixth embodiment lies in that in the embodiment, because the first winding 221 and the second winding 222 are arranged adjacent to each other, an air gap does not need to be arranged, and only the distance between the two windings is required to meet electrical isolation, so that a high coupling coefficient can be realized; and therefore, small dynamic inductance and high steady-state inductance are realized, and excellent dynamic performance and high conversion efficiency are obtained. In addition, in other embodiments, in the embodiment, the magnetic core 210 can adopt a magnetic powder core and a hot-press forming process, the magnetic core 210 and the winding 221/222 are integrally pressed to form an inductor, the integrally-formed inductor can simplify the manufacturing process, and the production efficiency is improved.

### Embodiment 8

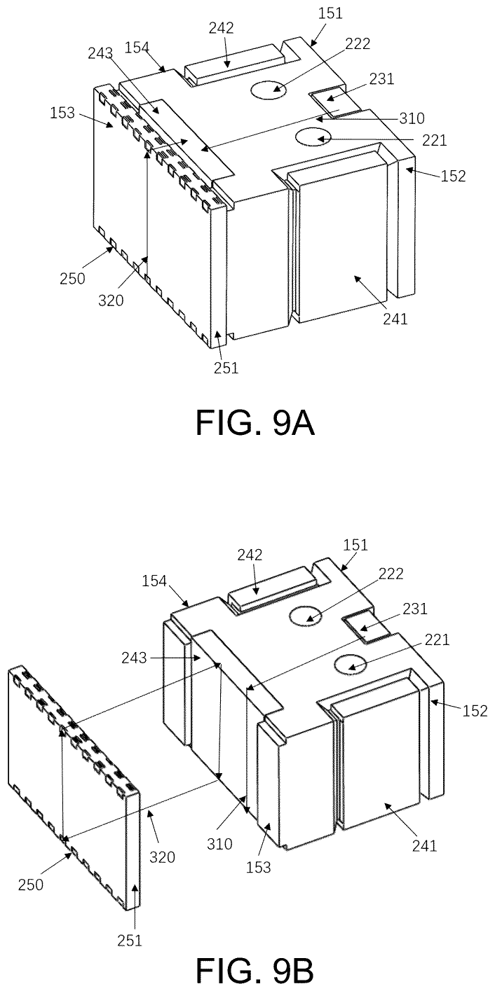

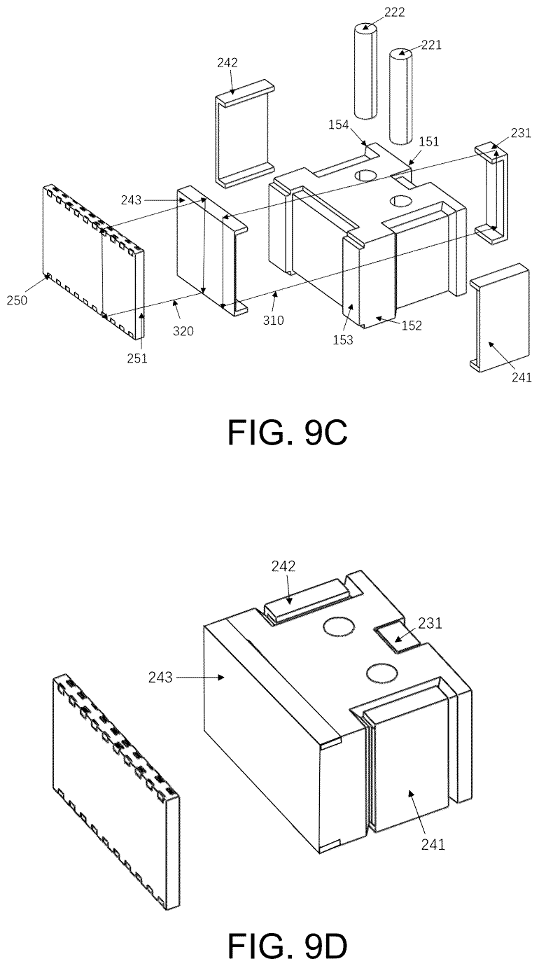

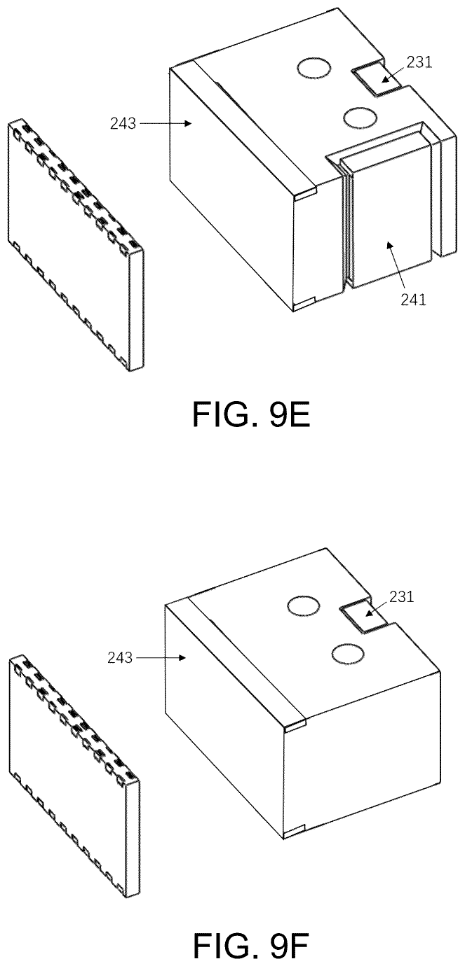

In the embodiment, in order to further increase the parasitic inductance on the input power loop 310, the signal loop 320 is further away from the VIN electrical connector 231. According to the embodiment, the GND electrical connector 243 is arranged adjacent to the third side surface 153 of the magnetic core 210, and the GND electrical connector 243 is arranged between the signal assembly 251 and the magnetic core body 210. FIG. 9A is a schematic structural diagram of an inductor assembly 200 according to an embodiment, and FIG. 9B and FIG. 9C are exploded schematic diagrams of FIG. 9A. The VRM module structure suitable for the embodiment is the same as the first embodiment, the VRM module structure comprises a top assembly 100, an intermediate assembly 200 and a bottom assembly 300; as shown in FIGS. 9A to 9C, the difference between the first embodiment and the current embodiment lies in that the inductor assembly 200; the VIN electrical connector 231 is disposed adjacent to the first side surface 151; the GND electrical connector comprises three parts, which are respectively 241, 242, and 243; the GND electrical connector 241 is disposed adjacent to the second side surface 152; the GND electrical connector 242 is disposed adjacent to the fourth side surface 154; the GND electrical connector 243 is disposed adjacent to the third side surface 153 and is disposed between the analog ground AGND and the magnetic core 210. The path of the input power loop 310 comprising the GND electrical connector 243 and the VIN electrical connector 231 is further increased, and the parasitic inductance on the input power loop 310 is increased, so that the resonant frequency of the input power loop resonance is far away from the working frequency of the VRM module. Furthermore, the GND electrical connector and the analog ground GND are arranged on the third side surface of the inductor assembly 200, so that the voltage difference between the power ground and the analog ground can be reduced. The GND electrical connector 243 can be arranged close to the magnetic core 210 and can also be integrated on the signal assembly 251, and the requirements of the application can be met as long as the GND electrical connector 243 is arranged between the simulation ground and the winding. The width of the GND electrical connector 243 can be less than the width of the third side surface 153, as shown in FIG. 9B, or can be equal to the width of the third side surface 153, as shown in FIG. 9D. In the technical effect, the GND electrical connector 243 needs to cover the third side surface 153 of the magnetic core 210 as much as possible, so that it is optimal than the two widths are equal.

In another embodiment, the GND electrical connector in the inductor assembly 200 may include two parts, which are 241 and 243 respectively, as shown in FIG. 9E; the GND electrical connector does not include a GND electrical connector 242, and the GND electrical connector 241 and 243 are disposed adjacent to the second side surface 152 and the third side surface 153, respectively. As shown in FIG. 9F, the GND electrical connector only comprises 243 and is arranged adjacent to the third side surface 153, and the technical effects disclosed in the above embodiment can also be obtained.

### Embodiment 9

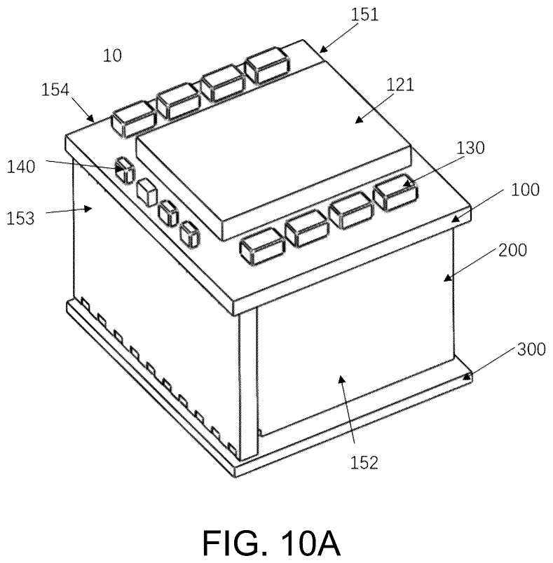

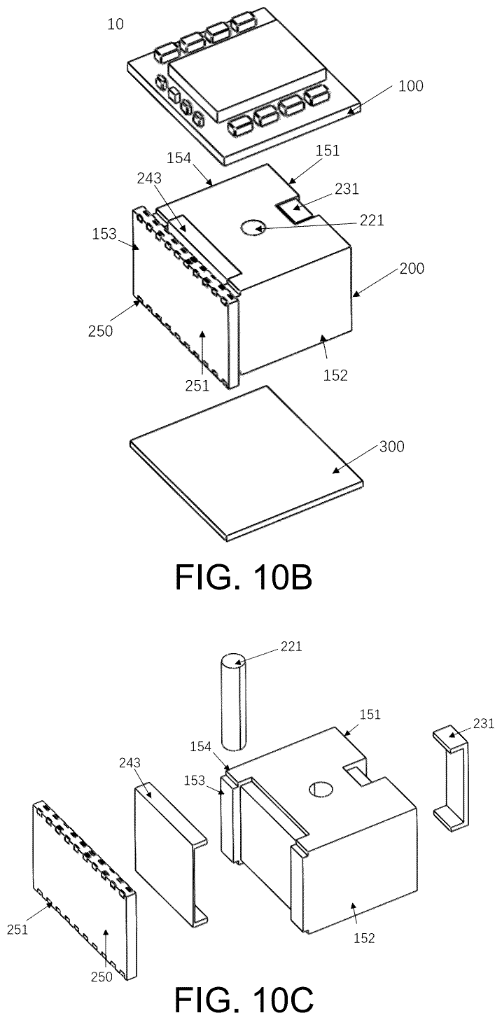

The application further provides a structure of the one-phase VRM module. As shown in FIG. 10A to 10C, the one-phase VRM module 10 comprises a top assembly 100, an inductor assembly 200 and the bottom assembly 300; the top assembly 100 comprises a first substrate 110, an IPM unit 121, a plurality of input capacitors 130 and other passive elements 140. The input capacitors 130 are arranged adjacent to the second side surface 152 and the fourth side surface 154 respectively, the other passive elements 140 are arranged adjacent to the third side surface 153, and the IPM unit 121 is arranged in an area enclosed by the first side surface 151, the input capacitor 130 and other passive elements 140. Correspondingly, the inductor assembly 200 only comprises one winding 221; the SW pin of the IPM unit 121 is electrically connected with one end of the winding 221, and furthermore, one end of the winding 221 is arranged vertically below the SW pin; the GND electrical connector can comprise three parts 241/242/243, and can also comprise two parts 241 and 243, and can also comprise only one GND electrical connector 243, and the arrangement position of the GND electrical connector is the same as that shown in the eighth embodiment, so that the same technical effect can be obtained.

The structure of the two-phase VRM module shown in the first embodiment to the eighth embodiment is suitable for a one-phase VRM module, and the technical effects disclosed by the application can be obtained.

The technical means from the first embodiment to the ninth embodiment can be combined with each other. For example, the first side surface or the third side surface of the magnetic core is provided with a groove, the technical solution for accommodating the VIN electrical connector 231 can be applied to all the embodiments described above, and the same benefits can be obtained; similarly, the technical solution that the auxiliary magnetic core 211 is provided on the outer side of the VIN electrical connector 231 is also applicable to all the embodiments described above.

In addition, the air gap can be applied to some embodiments when needed, and details are not described herein again.

### Embodiment 10

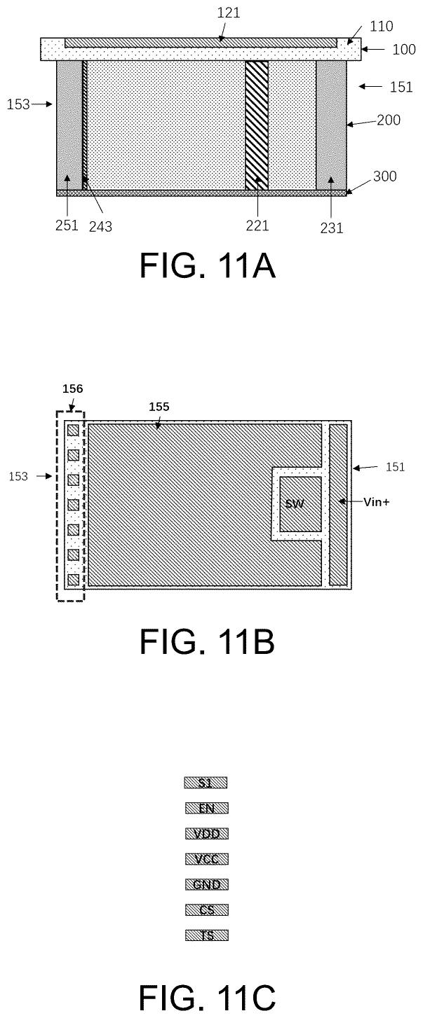

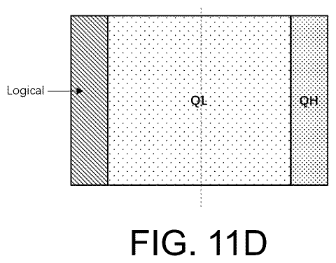

The embodiment also discloses the layout of the pin position of the IPM unit 121 and the layout of the internal wafer suitable for the structure of the embodiment. FIG. 11A is a schematic side view from the perspective of the second side surface 152, FIG. 11B is a schematic diagram of a pin layout of the IPM unit 121, FIG. 11C is a schematic diagram of signal pin layout of the IPM unit 121, and FIG. 11D is a schematic diagram of layout of a wafer inside the IPM unit. FIG. 11A to FIG. 11C can be applied to a one-phase VRM module, and can also be applied to a two-phase VRM module. As shown in FIG. 11A, the IPM unit 121 is embedded in the first substrate 110, and the pins of the IPM unit 121 is electrically connected to the electrical connector corresponding to the inductor assembly 200 and one end of the winding respectively by means of the wiring in the first substrate 110.

As shown in FIG. 11A and FIG. 11B, the IPM unit comprises a Vin+ pin, an SW pin, a power ground pin 155 and a signal pin area 156. The Vin+ pin is arranged adjacent to the first side surface 151, the Vin electrical connector 231 in the intermediate assembly 200 is arranged adjacent to the first side surface 151, and the Vin+ pin is electrically connected with the Vin electrical connector 231 nearby; the signal pin area 156 is arranged adjacent to the third side surface 153, the signal assembly 251 of the intermediate assembly 200 is arranged adjacent to the third side surface 153, the signal pins and the signal assembly 251 are arranged nearby, and the signal pins and the signal assembly 251 are used for setting a control signal pin required by the IPM unit 121, a state pin of the IPM unit 121, an analog ground pin and the like. The power ground pin with the large-area 155 is arranged between the Vin+ pin and the signal pin area and is used for realizing the large current requirement of the IPM unit 121. The SW pin is arranged between the Vin+ pin and the power ground pin and is arranged nearby one end of the winding 221. According to the structure of the IPM pin position layout combined with the inductor assembly disclosed by the embodiment, the shortest electrical connection path in the VRM module can be realized, so that the loss in the VRM module is reduced, and the complexity of internal wiring of the first substrate 110 is simplified.

A detailed layout within the signal pin area 156 may be described with reference to FIG. 11C, but is not limited thereto.

As shown in FIG. 11B and FIG. 11D, the IPM unit 121 is a single wafer and comprises an upper switch QH area, a lower switch QL area and a LOGICAL area, the upper switch QH area is arranged adjacent to the first side surface, the LOGICAL area is arranged adjacent to the third side surface, and the lower switch QL area is arranged between the upper switch QH area and the LOGICAL area. An upper switch QH arranged in the upper switch QH area and a lower switch QL arranged in the lower switch QL area are electrically connected to the SW pin in series, one end of the upper switch QH is electrically connected with the VIN+ pin, and one end of the lower switch QL is electrically connected with a power ground pin 155. The LOGICAL area is used for setting a required signal of the upper switch QH and the lower switch QL and a connecting wire of the analog ground AGND. The upper switch QH is arranged on the right side of the central axis of the single wafer; and in the composition of the upper switch QH, the semiconductor material exceeds 50%.

The IPM pin layout and the internal wafer layout shown in the embodiment are not limited to the VRM module shown in the embodiment, and are also suitable for VRM modules or other power converters with other structures.

In the VRM module 10 shown in the present application, the included IPM unit 121 may include at least one DRMOS, that is, the DRMOS includes at least two power switches connected in series and a driver required for the power switches; but the IPM unit is not limited to DRMOS, it can be any switch, as long as the technical features described above and the foregoing technical benefits can be obtained. In the VRM 10, one surface of the IPM unit 121 is arranged as the upper surface of the VRM module 10, the upper surface serves as a main heat dissipation surface of the power switch, and 60% of heat generated by the module can be dissipated. The power ground pin of the IPM unit 121 is connected to the PGND pin of the lower surface of the VRM module 10 through a GND electrical connector; and an input positive pin of the IPM unit is connected to a Vin+ pin on the lower surface of the VRM module 10 through the VIN electrical connector; the SW pin of the IPM unit is electrically connected with one end of the winding; and furthermore, one end of the winding is arranged vertically below the SW pin; the input capacitor 130 is arranged on the top assembly 100 and is electrically connected with the input positive pin and the power ground pin of the IPM unit 121; and related signal pins and signal ground pins of the IPM unit 121 are electrically connected with pins of the lower surface of the VRM module 10 through corresponding connectors on the signal assembly 251, and are used for receiving control signals of the system and/or reporting the working state of the VRM module 10 to the system.

In this invention, the connection between the top assembly and the inductor assembly, the connection between the inductor assembly and the bottom assembly are using the bonding pad. However, this is not limited to the bonding pad; other connecting parts, such as those fixed by conductive adhesives, can also be used.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

In addition, relational terms such as first and second are used herein to distinguish one entity or operation from another entity or operation, and do not necessarily require or imply that there is any such actual relationship or sequence between these entities or operations. Moreover, the terms “comprising”, “including” or any other variation thereof are intended to cover a non-exclusive inclusion, such that a process, method, article, or device that includes a series of elements includes not only those elements, but also other elements that are not explicitly listed, or elements inherent to such a process, method, article, or device. In the absence of more restrictions, a statement comprising a defined element does not preclude the existence of additional identical elements in the process, method, article, or device that includes the element.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. An inductor assembly, comprising an integrated inductor and a signal assembly; wherein the integrated inductor comprises a magnetic core and a winding, the integrated inductor is provided with a side surface, a top surface and a bottom surface opposite to each other, the side surface comprises a first side surface, a second side surface, a third side surface and a fourth side surface; the second side surface and the fourth side surface are adjacent to the third side surface respectively;
a top surface connecting part is arranged on the top surface of the integrated inductor, and a bottom surface connecting part is arranged on the bottom surface of the integrated inductor;
the signal assembly comprises a signal electrical connector and a shielding layer, the shielding layer is disposed between the signal electrical connector and the magnetic core; the signal assembly is arranged close to the third side surface of the integrated inductor; the signal connector and the winding are connected with the top surface connecting part and the bottom surface connecting part.

2. The inductor assembly of claim 1, wherein the shielding layer is an inner metal layer; the signal assembly further comprises an outer metal layer; and the signal electrical connector is arranged between the outer metal layer and the inner metal layer; the inner metal layer is arranged adjacent to the third side surface of the integrated inductor.

3. The inductor assembly of claim 2, wherein the outer metal layer and the inner metal layer are used for an analog ground.

4. The inductor assembly of claim 2, wherein the outer metal layer and the inner metal layer are large-area copper laying layers.

5. The inductor assembly of claim 2, wherein copper laying or wiring of the outer metal layer and the inner metal layer is around a periphery of the signal assembly, and wiring of the signal electrical connector is distributed around the periphery of the signal assembly.

6. The inductor assembly of claim 2, wherein the outer metal layer, the inner metal layer and the signal connector are arranged in a vertical plate.

7. The inductor assembly of claim 1, wherein the winding comprises a first winding and a second winding; an air gap is formed between the first winding and the second winding; and a coupling coefficient between the first winding and the second winding is greater than or equal to 0.2.

8. The inductor assembly of claim 1, wherein the winding comprises a first winding and a second winding, and the first winding and the second winding are both “Z”-shaped copper sheets; the first winding and the second winding both comprise a main body part, and the main body part of the first winding and the main body part of the second winding are arranged in parallel.

9. The inductor assembly of claim 8, wherein the top surface connecting part of the first winding and the second winding are both disposed adjacent to the first side surface, and the bottom surface connecting part of the first winding and the second winding are both disposed adjacent to the third side surface.

10. The inductor assembly of claim 8, wherein the top surface connecting part of the first winding and the bottom surface connecting part of the second winding are arranged close to the second side surface; and the bottom surface connecting part of the first winding and the top surface connecting part of the second winding are arranged close to the fourth side surface.

11. The inductor assembly of claim 8, wherein two ends of the main body part of each of the first winding and the second winding are respectively exposed out of two opposite side surfaces of the magnetic core.

12. The inductor assembly of claim 1, wherein the winding comprises a first winding and a second winding, and the first winding and the second winding penetrate through a bottom surface from a top surface of the magnetic core.

13. A voltage regulation module (VRM) module, comprising the inductor assembly of claim 1 and a top assembly, wherein the top assembly is disposed on a top surface of the inductor assembly, and the top assembly is electrical connected with the top surface connecting part.

14. The VRM module of claim 13, further comprising a bottom assembly, wherein the bottom assembly is disposed on the bottom surface of the inductor assembly, and the bottom assembly is electrical connected with the bottom surface connecting part; the bottom assembly is used for being connected with a load; the top assembly and/or the bottom assembly is electrical connected with a power ground.

15. The VRM module of claim 14, wherein the VRM module further comprises a first power electrical connector and a second power electrical connector, and the first power electrical connector and the second power electrical connector are respectively disposed adjacent to different side surfaces of the integrated inductor; the first power electrical connector and the second power electrical connector form a top surface power connecting part on the top surface of the integrated inductor respectively, and the top surface power connecting part is connected with the corresponding top assembly; the first power electrical connector and the second power electrical connector form a bottom surface power connecting part on the bottom surface of the integrated inductor respectively, the bottom surface connector bonding pad is used for being connected with the input end of the VRM module, and the input end is a power input end; the shielding layer is an inner metal layer; the signal assembly further comprises an outer metal layer; and the signal electrical connector is arranged between the outer metal layer and the inner metal layer; the inner metal layer is arranged adjacent to the third side surface of the integrated inductor; the outer metal layer and the inner metal layer are used for an analog ground; the analog ground is electrical connected with the power ground through the top assembly and/or the bottom assembly.

16. The VRM module of claim 14, wherein the top assembly comprises a semiconductor switching device; the top surface connecting part of the winding is vertically corresponding to and electrically connected with the connecting end of the semiconductor switching device.

17. The VRM module of claim 15, wherein the top assembly further comprises an input capacitor, and an electrical loop comprising the first power electrical connector, the second power electrical connector and the input capacitor, the electrical loop surrounds at least a part of the magnetic core.

18. The VRM module of claim 15, wherein the first power electrical connector is a VIN electrical connector, and the second power electrical connector is a GND electrical connector; the first power electrical connector is arranged close to the third side surface or the first side surface of the integrated inductor; and the second power electrical connector is arranged adjacent to the second side surface and the fourth side surface.

19. The VRM module of claim 15, wherein the first power electrical connector is a VIN electrical connector, and the second power electrical connector is a GND electrical connector; the first power electrical connector is arranged adjacent to the first side surface of the integrated inductor; and the second power electrical connector is arranged adjacent to the third side surface, the second side surface and/or the fourth side surface.

20. The VRM module of claim 19, wherein a width of the second power electrical connector disposed adjacent to the third side surface is equal to or less than a width of the third side surface of the integrated inductor.

21. The VRM module of claim 15, wherein the first power electrical connector and the second power electrical connector are metal sheets, and the first power electrical connector and the second power electrical connector are assembled with the magnetic core or sintered together.

22. The VRM module of claim 19, further comprising a groove, wherein the groove is disposed on the third side surface or the first side surface of the integrated inductor; the first power electrical connector is disposed in the groove of the third side surface or in the groove of the first side surface of the integrated inductor.

23. The VRM module of claim 22, wherein the magnetic core comprises a magnetic core main body and an auxiliary magnetic core, the first power electrical connector is arranged in a groove on the third side surface of the magnetic core main body, and the auxiliary magnetic core is arranged between the first power electrical connector and the signal assembly.

24. The VRM module of claim 23, wherein the material of the auxiliary magnetic core is configured to be a material of the magnetic core main body, a magnetic adhesive having different equivalent magnetic permeability to the magnetic core main body, or other types of alloy magnetic materials.

25. The VRM module of claim 15, wherein the first power electrical connector and the second power electrical connector are formed by bending a rectangular copper sheet; a placement groove is formed in the position on the surface of the magnetic core, the position is corresponding to the first power electrical connector and the second power electrical connector; and the tail end of the second power electrical connector is arc-shaped.

26. The VRM module of claim 16, wherein there are two semiconductor switch devices, the semiconductor switch devices comprise signal pins, and the signal pins are arranged adjacent to the third side surface; the VRM module further comprises an input capacitor, and the input capacitor is arranged between the semiconductor switch devices and adjacent to the third side surface.

27. The VRM module of claim 16, wherein the semiconductor switching device comprises a first semiconductor switching device and a second semiconductor switching device, and each semiconductor switching device comprises an SW end; the SW end of the first semiconductor switching device is arranged adjacent to the first side surface, and the SW end of the second semiconductor switching device is arranged adjacent to the third side surface; and the VRM module further comprises an input capacitor, and the input capacitor is arranged around and between the semiconductor switching device.

28. A VRM module, comprising a top assembly, an inductor assembly and a bottom assembly;
wherein the inductor assembly comprises an integrated assembly and a signal assembly; the integrated assembly comprises a power electrical connector, a magnetic core and a winding;
the integrated inductor is provided with a side surface, a top surface and a bottom surface opposite to each other, the side surface comprises a first side surface, a second side surface, a third side surface and a fourth side surface; the second side surface and the fourth side surface are adjacent to the third side surface respectively;
the signal assembly comprises a signal electrical connector;
a top surface connecting part is arranged on the top surface of the integrated inductor, and a bottom surface connecting part is arranged on the bottom surface of the integrated inductor; the power electrical connector, the signal electrical connector and the winding are electrical connected with the top surface connecting part and the bottom surface connecting part;
the power electrical connector comprises a power ground electrical connector; the signal electrical connector is arranged adjacent to the power ground electrical connector;
the inductor assembly is arranged between the top assembly and the bottom assembly; the top assembly and the bottom assembly are electrical connected with the inductor assembly through the top surface connecting part and the bottom surface connecting part.

29. The VRM module of claim 28, wherein the signal assembly further comprises an inner metal layer and an outer metal layer; and the signal electrical connector is arranged between the outer metal layer and the inner metal layer; the inner metal layer is arranged adjacent to the third side surface of the integrated inductor; the outer metal layer and the inner metal layer are used for an analog ground; the analog ground is electrical connected with the power ground electrical connector through the top assembly and/or the bottom assembly.

30. The VRM module of claim 29, wherein the power ground electrical connector is the second power electrical connector; the power electrical connector further comprises a first power electrical connector; the first power electrical connector is arranged adjacent to the first surface of the integrated inductor.

31. A pin layout of a semiconductor switch device, comprising a Vin+ pin, an SW pin, a power ground pin and a signal pin area; wherein the semiconductor switch device comprises a first side surface and a third side surface which are opposite to each other, and a second side surface and a fourth side surface which are opposite to each other; the Vin+ pin is adjacent and is arranged along the first side surface; the signal pin area is adjacent and is arranged along the third side surface;
the power ground pin is arranged between the Vin+ pin and the signal pin area; and the SW pin is arranged between the Vin+ pin and the power ground pin.

32. The pin layout of claim 31, wherein the signal pin area comprises a control signal pin, a state pin and an analog ground pin of the semiconductor switch device.

33. The pin layout of claim 31, wherein the semiconductor switch device is a single wafer and comprises an upper switch QH area, a lower switch QL area and a LOGICAL area; the upper switch QH area is arranged adjacent to the first side surface, and the LOGICAL area is arranged adjacent to the third side surface; and the lower switch QL area is arranged between the upper switch QH area and the LOGICAL area.

34. The pin layout of claim 33, wherein a semiconductor material in the upper switch QH area exceeds 50%.
